(19) United States
(12) Patent Application Publication
(10) Pub. No.: US 2012/0129989 A1
(43) Pub. Date: May 24, 2012

(54) Thermoplastic Resin Composition and Molded Product Using the Same

(75) Inventors: Bang-Duk KIM, Uiwang-si (KR); Jung-Eun PARK, Uiwang-si (KR); Doo-Han HA, Uiwang-si (KR)

(73) Assignee: CHEIL INDUSTRIES INC., Gumi-si (KR)

(21) Appl. No.: 13/362,068

(22) Filed: Jan. 31, 2012

Related U.S. Application Data
(63) Continuation-in-part of application No. PCT/KR2009/007917, filed on Dec. 29, 2009.

(30) Foreign Application Priority Data
Jul. 31, 2009 (KR) 10-2009-0070938

(51) Int. Cl. C08K 5/52; C08K 5/134

(52) U.S. Cl. 524/128; 524/290; 524/151

(57) ABSTRACT

Provided is a thermoplastic resin composition that includes (A) a base resin including (A-1) a polycarbonate resin and (A-2) a polyester resin, (B) a styrene-based polymer, (C) an impact-reinforcing agent and (D) a phenol-based antioxidant.

### CROSS-REFERENCE TO RELATED APPLICATIONS

This application is a continuation-in-part of International Application No. PCT/KR2009/007917 filed Dec. 29, 2009, pending, which designates the U.S., published as WO 2011/013882, and is incorporated herein by reference in its entirety. This application also claims priority to and the benefit of Korean Patent Application No. 10-2009-0070938 filed in the Korean Intellectual Property Office on Jul. 31, 2009, the entire disclosure of which is also incorporated herein by reference.

### FIELD OF THE INVENTION

This disclosure relates to a thermoplastic resin composition and a molded product using the same.

### BACKGROUND

Recently the requirement for a thermoplastic resin with excellent thermal stability and dimensional stability as a material for parts of an electric/electronic device, an automobile, and the like has increased. In other words, there has been increased emphasis on the importance of thermal stability, as the thermoplastic resin may need to remain longer inside an extruder in order to produce a molded product with a larger size at a lower cost depending on the use of the molded parts.

In addition, when an injection molding product has a complex shape, it can change shape after extrusion from its originally-desired design. Accordingly, since transformation of the shape of the molded product should be suppressed, post-transformation of a resin itself should also be suppressed.

A conventional mixture of an aromatic polycarbonate and polyethylene terephthalate has high impact resistance and has been widely used for parts exposed to an impact. However, the conventional mixture can generate gas during extrusion due to low thermal stability when used to make an exterior part with a large size for an automobile and the like. The desired shape of molded products made using this conventional mixture can also change after extrusion, which can cause assembly problems.

Since the aromatic polycarbonate and the polyethylene terephthalate exchange an ester by a carboxyl group at the end of the polyethylene terephthalate, the mixture may have weak thermal stability. In addition, since the aromatic polycarbonate and the polyethylene terephthalate have low compatibility with each other, the mixture may undergo phase separation while cooling after extrusion, and as a result additional dimension transformation may occur after extrusion. Therefore, the mixture of the aromatic polycarbonate and polyethylene terephthalate is not used much, while a mixture of the aromatic polycarbonate and polybutylene terephthalate is in wide commercial use.

### SUMMARY

One embodiment provides a thermoplastic resin composition that can have excellent heat resistance, thermal stability, and dimensional stability as well as excellent mechanical properties such as impact resistance.

Another embodiment provides a molded product manufactured using the thermoplastic resin composition.

One embodiment of the present invention provides: (A) about 100 parts by weight of a base resin including (A-1) about 55 to about 80 wt % of a polycarbonate resin and (A-2) about 20 to about 45 wt % of a polyester resin; (B) about 1 to about 10 parts by weight of a styrene-based polymer; (C) about 1 to about 20 parts by weight of an impact-reinforcing agent; and (D) about 0.01 to about 5 parts by weight of a phenol-based antioxidant, wherein the amount of (B), (C) and (D) are each based on about 100 parts by weight of the base resin.

The base resin (A) may include about 60 to about 80 wt % of the polycarbonate resin (A-1) and about 20 to about 40 wt % of the polyester resin (A-2).

The polycarbonate resin (A-1) may be prepared by reacting one or more diphenols with a compound such as phosgene, a halogenic acid ester, a carbonate ester, or a combination thereof, and may have a weight average molecular weight of about 10,000 to about 40,000 g/mol.

The polyester resin (A-2) may be a polybutylene terephthalate resin or a polyethylene terephthalate resin. The polybutylene terephthalate resin may have an intrinsic viscosity [η] of about 0.35 to about 1.5 dl/g, and the polyethylene terephthalate resin may have an intrinsic viscosity [η] of about 0.6 to about 1 dl/g.

The styrene-based polymer (B) may be a polymer prepared by polymerizing about 60 to about 100 wt % of a styrene-based monomer and about 0 to about 40 wt % of a vinyl cyanide monomer.

The impact-reinforcing agent (C) may be a core-shell structured copolymer, in which a polymer comprising an acrylic-based monomer, an aromatic vinyl monomer, an unsaturated nitrile monomer or a combination thereof, is grafted into a rubbery polymer prepared by polymerizing a diene-based monomer, an acrylic-based monomer, a silicon-based monomer, a styrene-based monomer, or a combination thereof. The rubbery polymer may include polybutadiene; a copolymer of butadiene and alkyl(meth)acrylate; a terpolymer of butadiene, alkyl(meth)acrylate and cyclosiloxane; and combinations thereof.

The phenol-based antioxidant (D) may include octadecyl-3-(3,5-di-t-butyl-4-hydroxyphenyl)propionate, pentaerythritol-ester, bis(3,3-bis(4′-hydroxy-3′-t-butylphenyl)butanoic acid)glycol ester, or a combination thereof.

The phenol-based antioxidant (D) may be mixed with a phosphite-based antioxidant. The phenol-based antioxidant (D) and the phosphite-based antioxidant may be mixed in a weight ratio ranging from about 1:4 to about 4:1.

The phosphite-based antioxidant may include tris(2,4-t-butyl phenyl)phosphite, tris(nonylphenyl)phosphite, bis(2,6-d-t-butyl-4-methylphenyl)pentaerytritol diphosphite, or a combination thereof.

The thermoplastic resin composition may further include one or more additives such as an antibacterial agent, a heat stabilizer, an antioxidant (which is different from the phenol-based antioxidant (D) and/or the phosphite antioxidant), a release agent, a light stabilizer, a compatibilizer, an inorganic material additive, a surfactant, a coupling agent, a plasticizer, an admixture, a colorant such as a dye or a pigment, a stabilizer, a lubricant, an antistatic agent, a coloring aid, a flameproofing agent, a weather-resistance agent, an ultraviolet (UV) absorber, an ultraviolet (UV) blocking agent, a filler, a nucleating agent, an adhesion aid, an adhesive, and the like, and combinations thereof.

Another embodiment provides a molded product manufactured using the thermoplastic resin composition.

Hereinafter, further embodiments of the present invention will be described in detail.

According to one embodiment, a thermoplastic resin composition can have excellent mechanical properties such as impact resistance and flexural modulus, excellent dimensional stability for a short cooling time in an extrusion process, excellent heat resistance, and excellent thermal stability, since a small amount of gas may be generated when left at a high temperature for a long time. Accordingly, the thermoplastic resin composition may be widely used in various products, for example molded products such as automobile exterior materials and the like.

### DETAILED DESCRIPTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

When a specific definition is not otherwise provided, the term “(meth)acrylate” refers to “acrylate” and “methacrylate,” “(meth)acrylic acid alkyl ester” refers to both “acrylic acid alkyl ester” and “methacrylic acid alkyl ester”, and “(meth)acrylic acid ester” refers to both “acrylic acid ester” and “methacrylic acid ester”.

When a specific definition is not otherwise provided, the term “combination thereof” refers to refers to a mixture, a stacked structure, a composite, a polymerization product, an alloy, or the like.

The thermoplastic resin composition according to one embodiment includes (A) about 100 parts by weight of a base resin including (A-1) about 55 to about 80 wt % of a polycarbonate resin and (A-2) about 20 to about 45 wt % of a polyester resin; (B) about 1 to about 10 parts by weight of a styrene-based polymer; (C) about 1 to about 20 parts by weight of an impact-reinforcing agent; and (D) about 0.01 to about 5 parts by weight of a phenol-based antioxidant, wherein the amount of each of (B), (C), and (D) are based on about 100 parts by weight of the base resin.

Each component included in the thermoplastic resin composition will hereinafter be described in detail.

(A) Base Resin

(A-1) Polycarbonate Resin

The polycarbonate resin according to one embodiment may be prepared by reacting one or more diphenols of the following Chemical Formula I with a compound such as a phosgene, a halogenic acid ester, a carbonate ester, or a combination thereof.

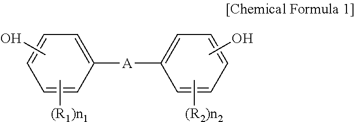

In Chemical Formula 1,

A is a linking group comprising a single bond, substituted or unsubstituted C1 to C30 linear or branched alkylene, substituted or unsubstituted C2 to C5 alkenylene, substituted or unsubstituted C2 to C5 alkylidene, substituted or unsubstituted C1 to C30 linear or branched haloalkylene, substituted or unsubstituted C5 to C6 cycloalkylene, substituted or unsubstituted C5 to C6 cycloalkenylene, substituted or unsubstituted C5 to C10 cycloalkylidene, substituted or unsubstituted C6 to C30 arylene, substituted or unsubstituted C1 to C20 linear or branched alkoxylene, halogenic acid ester group, carbonate ester group, CO, S, or SO₂,

R₁ and R₂ are the same or different and are each independently substituted or unsubstituted C1 to C30 alkyl or substituted or unsubstituted C6 to C30 aryl, and

n₁ and n₂ are the same or different and are each independently integers ranging from 0 to 4.

As used herein, unless otherwise defined, the term “substituted” refers to a group substituted with at least one or more substituents comprising halogen, C1 to C30 alkyl, C1 to C30 haloalkyl, C6 to C30 aryl, C1 to C20 alkoxy, or a combination thereof instead of a hydrogen atom.

The diphenols represented by the above Chemical Formula 1 may be used in combinations to constitute repeating units of the polycarbonate resin. Examples of the diphenols include without limitation hydroquinone, resorcinol, 4,4′-dihydroxydiphenyl, 2,2-bis(4-hydroxyphenyl)propane (referred to as “bisphenol-A”), 2,4-bis(4-hydroxyphenyl)-2-methylbutane, bis(4-hydroxyphenyl)methane, 1,1-bis(4-hydroxyphenyl)cyclohexane, 2,2-bis(3-chloro-4-hydroxyphenyl)propane, 2,2-bis(3,5-dimethyl-4-hydroxyphenyl)propane, 2,2-bis(3,5-dichloro-4-hydroxyphenyl)propane, 2,2-bis(3,5-dibromo-4-hydroxyphenyl)propane, bis(4-hydroxyphenyl)sulfoxide, bis(4-hydroxyphenyl)ketone, bis(4-hydroxyphenyl)ether, and the like, and combinations thereof. In exemplary embodiments, 2,2-bis(4-hydroxyphenyl)propane, 2,2-bis(3,5-dichloro-4-hydroxyphenyl)propane, 1,1-bis(4-hydroxyphenyl)cyclohexane or a combination thereof may be used, for example, 2,2-bis(4-hydroxyphenyl)propane may be used.

The polycarbonate resin may have a weight average molecular weight ranging from about 10,000 to about 200,000 g/mol, for example about 10,000 to about 40,000 g/mol. When the polycarbonate resin has a weight average molecular weight within the above range, excellent properties such as impact strength and excellent workability due to appropriate fluidity may be obtained. In addition, two or more different kinds of polycarbonate resins with different weight average molecular weights may be mixed in order to improve fluidity.

The polycarbonate resin may be a mixture of copolymers obtained using two or more diphenols that differ from each other. The polycarbonate resin may include a linear polycarbonate resin, a branched polycarbonate resin, a polyestercarbonate copolymer resin, and the like and combinations thereof.

The linear polycarbonate resin may include a bisphenol-A-based polycarbonate resin. The branched polycarbonate resin may be produced by reacting a multi-functional aromatic compound such as trimellitic anhydride, trimellitic acid, and the like with one or more diphenols and a carbonate. The multi-functional aromatic compound may be included in an amount of about 0.05 to about 2 mol % based on the total weight of the branched polycarbonate resin. The polyester carbonate copolymer resin may be produced by reacting difunctional carboxylic acid with one or more diphenols and a carbonate. The carbonate may include a diaryl carbonate such as diphenyl carbonate, ethylene carbonate, and the like, and combinations thereof.

The base resin may include the polycarbonate resin in an amount of about 55 to about 80 wt %, for example about 60 to about 80 wt %, based on the total weight of the base resin including the polycarbonate resin and polyester resin. In some embodiments, the base resin may include the polycarbonate resin in an amount of about 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of the polycarbonate resin can be in a range from about any of the foregoing amounts to about any other of the foregoing amounts.

When the base resin includes the polycarbonate resin in an amount within the above range, heat resistance and impact strength as well as chemical resistance and weather resistance can be improved.

(A-2) Polyester Resin

According to one embodiment, a polyester resin can be an aromatic polyester resin and may be a condensation-polymerized resin prepared by melt-polymerizing terephthalic acid or a terephthalic acid alkyl ester with a glycol component having 2 to 10 carbon atoms. As used herein, the term alkyl may be C1 to C10 alkyl.

Examples of the aromatic polyester resin may include without limitation a polyethylene terephthalate resin, a polytrimethylene terephthalate resin, a polybutylene terephthalate resin, a polyhexamethylene terephthalate resin, a polycyclohexane dimethylene terephthalate resin, a polyester resin prepared by mixing these resins with other monomers and modifying the mixture to be non-crystalline, and the like, and combinations thereof. In exemplary embodiments, the polyester resin may include a polyethylene terephthalate resin, a polytrimethylene terephthalate resin, a polybutylene terephthalate resin, a non-crystalline polyethylene terephthalate resin, and the like, and combinations thereof. In further exemplary embodiments, the polyester resin may include a polybutylene terephthalate resin, a polyethylene terephthalate resin and the like, and combinations thereof.

The polybutylene terephthalate resin may be a condensation-polymerized polymer prepared by direct esterification or transesterification of a 1,4-butanediol monomer with terephthalic acid or a dimethyl terephthalate monomer.

In addition, in order to increase impact strength of a polybutylene terephthalate resin, the polybutylene terephthalate resin may be copolymerized with polytetramethylene glycol (PTMG), polyethylene glycol (PEG), polypropylene glycol (PPG), an aliphatic polyester with a low molecular weight, or an aliphatic polyamide, or a combination thereof, or modified by blending with an impact-improving component.

The polybutylene terephthalate resin may have an intrinsic viscosity [η] of about 0.35 to about 1.5 dl/g, for example about 0.5 to about 1.3 dl/g, when measured in o-chloro phenol at 25° C. When the polybutylene terephthalate resin has an intrinsic viscosity within the above range, the polybutylene terephthalate resin can have excellent mechanical strength and formability.

The polyethylene terephthalate resin can be a linear resin prepared by condensation-polymerizing terephthalic acid and ethylene glycol, and can include a polyethylene terephthalate homopolymer, a polyethylene terephthalate copolymer, or a combination thereof.

In addition, the polyethylene terephthalate copolymer may be a non-crystalline polyethylene terephthalate copolymer including 1,4-cyclohexane dimethanol (CHDM) as a copolymerization component or a copolymer including 1,4-cyclohexane dimethanol replacing a part of an ethylene glycol component. In exemplary embodiments, the amount of 1,4-cyclohexane dimethanol in the ethylene glycol component may range from an amount of about 3 to about 48 mol %, for example about 5 to about 20 mol %. When the amount of 1,4-cyclohexane dimethanol is within the above range, surface smoothness and heat resistance may be improved.

The polyethylene terephthalate resin may have an intrinsic viscosity [η] of about 0.6 to about 1 dl/g, for example about 0.7 to about 0.9 dl/g when it is prepared by dissolving a polyethylene terephthalate resin in an amount about of 0.5 wt % in a viscous solvent prepared by mixing phenol and tetrachloroethane at a weight ratio of about 50:50 and measuring the intrinsic viscosity [η] at 30° C. When the polyethylene terephthalate resin has an intrinsic viscosity within the above range, excellent mechanical strength and formability may be obtained.

The base resin may include the polyester resin in an amount of about 20 to about 45 wt %, for example about 20 to about 40 wt %, based on the total weight of a base resin including a polycarbonate resin and a polyester resin. In some embodiments, the base resin may include the polyester resin in an amount of about 20, 21, 22, 23, 24, 25, 26, 27, 28, 29, 30, 31, 32, 33, 34, 35, 36, 37, 38, 39, 40, 41, 42, 43, 44, or 45 wt %. Further, according to some embodiments of the present invention, the amount of the polyester resin can be in a range from about any of the foregoing amounts to about any other of the foregoing amounts.

When the base resin includes a polyester resin in an amount within the above range, excellent heat resistance and impact resistance as well as excellent chemical resistance and weather resistance may be obtained.

(B) Styrene-Based Polymer

According to one embodiment, a styrene-based polymer can play a role of increasing compatibility of a polycarbonate resin with a polyester resin and thus can help suppress the domain size of the polyester resin from having a larger size during the cooling in the extrusion process, and further may suppress transformation or changes in the molded product due to slow crystallization of the polyester resin. As used herein, the term “domain” indicates a discontinuous phase in contrast to “a matrix” with a continuous phase.

The styrene-based polymer can include a polymer prepared by polymerizing about 60 to about 100 wt % of a styrene-based monomer and about 0 to about 40 wt % of a vinyl cyanide monomer.

In some embodiments, the styrene-based polymer can include a styrene-based monomer in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 wt %. Further, according to some embodiments of the present invention, the amount of the styrene-based monomer can be in a range from about any of the foregoing amounts to about any other of the foregoing amounts.

In some embodiments, the styrene-based polymer can include a vinyl cyanide monomer in an amount of 0 wt % (the vinyl cyanide monomer is not present) or about 0 (the vinyl cyanide monomer is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 wt %. Further, according to some embodiments of the present invention, the amount of the vinyl cyanide compound can be in a range from about any of the foregoing amounts to about any other of the foregoing amounts.

When the vinyl cyanide monomer is used in an amount within the above range, a polycarbonate resin and a polyester resin may exhibit excellent compatibility.

Examples of the styrene-based polymer may include without limitation copolymers of a styrene-based monomer and a vinyl cyanide monomer, polystyrene prepared by polymerizing only a styrene-based monomer, and combinations thereof.

The copolymer of a styrene-based monomer and a vinyl cyanide monomer may have a weight average molecular weight ranging from about 40,000 to about 500,000 g/mol.

Examples of the styrene-based monomer may include without limitation styrene; divinylbenzene; vinyltoluene; alkyl-substituted styrene such as α-methylstyrene, p-t-butylstyrene, 2,4-dimethylstyrene, and the like; halogen-substituted styrene; and the like; and combinations thereof. As used herein, the alkyl may be C1 to C8 alkyl.

Examples of the vinyl cyanide monomer may include without limitation acrylonitrile, methacrylonitrile, and the like, and combinations thereof.

The copolymer of a styrene-based monomer and a vinyl cyanide monomer may be prepared in an emulsion polymerization method, a suspension polymerization method, a solution polymerization method, a massive polymerization method, and the like.

The copolymer of a styrene-based monomer and a vinyl cyanide monomer may be prepared by polymerizing about 60 to about 99.9 wt % of a styrene-based monomer and about 0.1 to about 40 wt % of a vinyl cyanide monomer. When the styrene-based monomer and the vinyl cyanide monomer are polymerized in amounts within the above range ratio, a polycarbonate resin can have a stably distributed phase, thereby improving impact resistance. Further, when a vinyl cyanide monomer is used in an amount within the above range, excellent compatibility of the polycarbonate resin with a polyester resin may be secured.

The thermoplastic resin composition may include the styrene-based polymer in an amount of about 1 to about 10 parts by weight, for example about 2 to about 8 parts by weight, based on about 100 parts by weight of a base resin including a polycarbonate resin and a polyester resin. In some embodiments, the thermoplastic resin composition may include the styrene-based polymer in an amount of about 1, 2, 3, 4, 5, 6, 7, 8, 9, or 10 parts by weight. Further, according to some embodiments of the present invention, the amount of the styrene-based polymer can be in a range from about any of the foregoing amounts to about any other of the foregoing amounts.

When the thermoplastic resin composition includes the styrene-based polymer in an amount within the above range, excellent compatibility between a polycarbonate resin and a polyester resin as well as excellent impact resistance, strength, and heat resistance may be obtained.

(C) Impact-Reinforcing Agent

According to one embodiment, an impact-reinforcing agent may increase impact resistance of a polycarbonate resin.

The impact-reinforcing agent may be a core-shell structured copolymer in which an unsaturated compound is grafted into a rubbery polymer. In exemplary embodiments, the unsaturated compound is a polymer prepared by polymerizing an acrylic-based monomer, an aromatic vinyl monomer, an unsaturated nitrile monomer, or combination thereof (i.e., can be a copolymer including two or more of the noted monomers). In exemplary embodiments, the rubbery polymer is prepared by polymerizing a diene-based monomer, an acrylic-based monomer, a silicon-based monomer, a styrene-based monomer, or a combination thereof.

Examples of the diene-based monomer included in the rubbery polymer may include without limitation butadiene, isoprene, and the like, and combinations thereof. In exemplary embodiments, the diene-based monomer may include butadiene.

Examples of the acrylic-based monomer used in the rubbery polymer may include without limitation alkyl(meth)acrylates such as methylacrylate, ethylacrylate, n-propylacrylate, n-butylacrylate, 2-ethylhexylacrylate, hexylmethacrylate, 2-ethylhexylmethacrylate, and the like, and combinations thereof. As used herein, the alkyl is C1 to C10 alkyl. In addition, a hardener such as ethylene glycol dimethacrylate, propylene glycol dimethacrylate, 1,3-butylene glycol dimethacrylate, 1,4-butylene glycol dimethacrylate, allylmethacrylate, triallylcyanurate, and the like, and combinations thereof may be used.

Examples of the silicon-based monomer used in the rubbery polymer may include without limitation cyclosiloxanes such as hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, octaphenylcyclotetrasiloxane, and the like, and combinations thereof. A curing agent such as trimethoxymethylsilane, triethoxyphenylsilane, tetramethoxysilane, tetraethoxysilane, and the like and combinations thereof may be used.

Examples of the styrene-based monomer used in the rubbery polymer may include without limitation styrene, C1-C10 alkyl-substituted styrene, halogen-substituted styrene, and the like, and combinations thereof.

Examples of the rubbery polymer may include without limitation polybutadiene, a copolymer of butadiene and alkyl(meth)acrylate, a terpolymer of butadiene, alkyl(meth)acrylate and cyclosiloxane, and the like. The rubbery polymers may be used in singularly or in a combination of two or more.

The rubbery polymer may have a rubber average particle diameter (weight basis) ranging from about 0.4 to about 1 μm to maintain impact resistance and coloring property.

The impact-reinforcing agent may include the rubbery polymer in an amount of about 20 to about 80 wt % based on the total weight of an impact-reinforcing agent according to one embodiment of the present invention. In some embodiments, the impact-reinforcing agent may include the rubbery polymer in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of the rubbery polymer can be in a range from about any of the foregoing amounts to about any other of the foregoing amounts.

When the impact-reinforcing agent includes the rubbery polymer in an amount within the above range, the impact reinforcement effect and heat resistance improvement may be maximized, and fluidity may also be significantly improved.

Examples of the acrylic-based monomer of the unsaturated monomer may include without limitation (meth)acrylic acid alkyl esters, (meth)acrylic acid esters, and the like, and combinations thereof. As used herein, the alkyl is C1 to C10 alkyl. Examples of the (meth)acrylic acid alkyl ester may include without limitation methyl(meth)acrylate, ethyl(meth)acrylate, propyl(meth)acrylate, butyl(meth)acrylate, and the like, and combinations thereof. In exemplary embodiments, the meth)acrylic acid alkyl ester may include methyl(meth)acrylate.

Examples of the aromatic vinyl monomer may include without limitation styrene, C1-C10 alkyl-substituted styrenes, halogen-substituted styrenes, and the like, and combinations thereof. Examples of the alkyl-substituted styrene may include without limitation o-ethyl styrene, m-ethyl styrene, p-ethyl styrene, α-methyl styrene, and the like and combinations thereof.

Examples of the unsaturated nitrile monomer may include without limitation acrylonitrile, methacrylonitrile, ethacrylonitrile, and the like, and combinations thereof.

The thermoplastic resin composition may include the impact-reinforcing agent in an amount of about 1 to about 20 parts by weight, for example about 6 to about 12 parts by weight, based on about 100 parts by weight of a base resin including a polycarbonate resin and a polyester resin. In some embodiments, the thermoplastic resin composition may include the impact-reinforcing agent in an amount of about 1, 2, 3, 4, 5, 6, 7, 8, 9, 10, 11, 12, 13, 14, 15, 16, 17, 18, 19, or 20 parts by weight. Further, according to some embodiments of the present invention, the amount of the impact-reinforcing agent can be in a range from about any of the foregoing amounts to about any other of the foregoing amounts.

When the thermoplastic resin composition includes the impact-reinforcing agent in an amount within the above range, the impact reinforcement effect and heat resistance may be maximized, and fluidity may also be improved, which can improve injection molding property.

(D) Phenol-Based Antioxidant

According to one embodiment, a phenol-based antioxidant that may be widely commercially available may be used. Examples of the phenol-based antioxidant may include without limitation octadecyl-3-(3,5-di-t-butyl-4-hydroxyphenyl)propionate, pentaerythritol-ester, bis(3,3-bis(4′-hydroxy-3′-t-butylphenyl)butanoic acid)glycol ester, and the like, which may be used singularly or in a combination of two or more. In addition, examples of commercially available products may include without limitation Irganox 1010 and Irganox 1076 made by Ciba-Geigy Co., and Hostanox O3P and the like made by Clariant Corp.

The phenol-based antioxidant may be mixed with a phosphite-based antioxidant and thus may further improve thermal stability.

The phosphite-based antioxidant may be widely commercially available. Examples of the phosphite-based antioxidant may include without limitation tris(2,4-t-butyl phenyl)phosphite, tris(nonylphenyl)phosphite, bis(2,6-d-t-butyl-4-methylphenyl)pentaerytritol diphosphite, and the like, which may be used singularly or in a combination of two or more.

The phenol-based antioxidant and the phosphite-based antioxidant may be mixed in a weight ratio ranging from about 1:4 to about 4:1.

In some embodiments, the mixture of the phenol-based antioxidant and the phosphite-based antioxidant may include the phenol-based antioxidant in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of the phenol-based antioxidant can be in a range from about any of the foregoing amounts to about any other of the foregoing amounts.

In some embodiments, the mixture of the phenol-based antioxidant and the phosphite-based antioxidant may include the phosphite-based antioxidant in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of the phosphite-based antioxidant can be in a range from about any of the foregoing amounts to about any other of the foregoing amounts.

When the phenol-based antioxidant and the phosphite-based antioxidant are mixed in an amount within the above ratio, the antioxidants may maximize synergy effects.

The thermoplastic resin composition may include the phenol-based antioxidant in an amount of about 0.01 to about 5 parts by weight, for example about 0.1 to about 1 parts by weight, based on about 100 parts by weight of a base resin including a polycarbonate resin and a polyester resin. In some embodiments, the thermoplastic resin composition may include the phenol-based antioxidant in an amount of about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, or 5 parts by weight. Further, according to some embodiments of the present invention, the amount of the phenol-based antioxidant can be in a range from about any of the foregoing amounts to about any other of the foregoing amounts.

When the thermoplastic resin composition includes the phenol-based antioxidant in an amount within the above range, excellent strength, heat resistance, and thermal stability may all be obtained.

(E) Other Additive(s)

The thermoplastic resin composition according to one embodiment may further include one or more additives. Examples of the additives include without limitation antibacterial agents, heat stabilizers, antioxidants (other than the phenol-based and/or phosphite-based antioxidants discussed herein), release agents, light stabilizers, compatibilizers, colorants such as dyes and pigments, inorganic material additives, surfactants, coupling agents, plasticizers, admixtures, stabilizers, lubricants, antistatic agents, coloring aids, flameproofing agents, weather-resistance agents, ultraviolet (UV) absorbers, ultraviolet (UV) blocking agents, fillers, nucleating agents, adhesion aids, adhesives, and the like, and combinations thereof, as needed

Examples of the release agent include without limitation fluorine-containing polymers, silicone oils, metal stearate salts, metal montanate salts, montanic acid ester waxes, polyethylene waxes, and the like, and combinations thereof. Examples of the weather-resistance agent may include without limitation benzophenone-type weather-resistance agents, amine-type weather-resistance agents, and the like, and combinations thereof. Examples of the colorant may include without limitation dye, pigments, and the like, and combinations thereof. Examples of the ultraviolet (UV) blocking agent may include without limitation titanium oxide (TiO₂), carbon black, and the like, and combinations thereof. Examples of the filler may include without limitation glass fiber, carbon fiber, silica, mica, alumina, clay, calcium carbonate, calcium sulfate, glass beads, and the like and combinations thereof. The filler may improve properties such as mechanical strength and heat resistance. Examples of the nucleating agent may include without limitation talc, clay, and the like, and combinations thereof.

The additive may be included in appropriate amounts, for example about 0.1 to about 30 parts by weight based on about 100 parts by weight of the base resin including polyester resin and polycarbonate resin, as long as it does not harm the properties of the thermoplastic resin composition.

The thermoplastic resin composition according to one embodiment may be prepared using well-known methods. For example, each component of the present invention can be is simultaneously mixed, optionally with one or more additives. The mixture can be melt-extruded and prepared into pellets.

According to another embodiment, the thermoplastic resin composition is molded to provide a molded product. The thermoplastic resin composition may be used to manufacture various products requiring mechanical properties such as impact resistance and the like, dimensional stability, and thermal stability, for example molded products such as exterior automobile parts and the like.

The following examples illustrate this disclosure in more detail. However, it is understood that this disclosure is not limited by these examples.

### EXAMPLES

A thermoplastic resin composition according to one embodiment includes each component as follows.

(A) Base Resin

(A-1) Polycarbonate Resin

A polycarbonate resin with a weight average molecular weight of 26,000 g/mol (SC-1080 made by Cheil Industries Inc.) is used

(A-2) Polyester Resin

A polyethylene terephthalate resin with an intrinsic viscosity [η] of 0.77 dl/g (SKYPET 1100 made by SK Chemicals Co. Ltd.) is used

(B) Styrene-Based Polymer

A styrene-acrylonitrile copolymer having a weight average molecular weight of about 100,000 g/mol and including 80 wt % of styrene and 20 wt % of acrylonitrile is used.

(C) Impact-Reinforcing Agent

(C-1) 223A made by Mitsubishi Rayon Chemical Co., Ltd. prepared by grafting polymethylmethacrylate into a rubbery polymer including a copolymer of butadiene and ethylacrylate is used.

(C-2) Metablen S-2100 made by Mitsubishi Rayon Chemical Co., Ltd., prepared by grafting polymethylmethacrylate into a rubbery polymer including a terpolymer of butadiene, ethylacrylate, and cyclosiloxane, is used.

(D) Phenol-Based Antioxidant

Irganox 1076 made by Ciba Special Chemical Co. Ltd. is used.

(D′) Non-Phenol-Based Antioxidant

Doverphos S-9288PC made by Dover Chemical Co. is used as a diphosphite-based antioxidant.

### Examples 1 to 4 and Comparative Examples 1 to 7

The aforementioned components are extruded in the amounts noted in the following Table 1 in a twin-screw extruder having a feed rate of 60 kg/hr, a screw rpm of 250, a temperature of 250° C., a screw configuration of 45φ Regular, and L/D=29, and then prepared into pellets.

TABLE 1

| | | Example | | | | Comparative Example | | | | | | |
|---|---|---|---|---|---|---|---|---|---|---|---|---|
| | | 1 | 2 | 3 | 4 | 1 | 2 | 3 | 4 | 5 | 6 | 7 |
| (A-1) polycarbonate resin | | 61 | 73 | 73 | 66 | 53 | 73 | 70 | 73 | 73 | 73 | 73 |
| (wt %) | | | | | | | | | | | | |
| (A-2) polyester resin | | 39 | 27 | 27 | 34 | 47 | 27 | 30 | 27 | 27 | 27 | 27 |
| (wt %) | | | | | | | | | | | | |
| (B) styrene-based polymer | | 5 | 2 | 2 | 3 | 5 | — | 12 | 2 | 2 | 2 | 2 |
| (parts by weight*) | | | | | | | | | | | | |
| (C) impact-reinforcing | C-1 | 10 | 8 | — | 9 | 10 | 8 | 8 | 25 | 8 | 8 | 8 |
| agent | C-2 | — | — | 8 | — | — | — | — | — | — | — | — |
| (parts by weight*) | | | | | | | | | | | | |

| | | | | | | | | | | | |
|---|---|---|---|---|---|---|---|---|---|---|---|
| (D) phenol-based | 0.6 | 0.2 | 0.3 | 1.0 | 0.3 | 0.3 | 0.3 | 0.3 | — | 5.5 | — |
| an antioxidant | | | | | | | | | | | |
| (parts by weight*) | | | | | | | | | | | |
| (D′) Non-phenol-based | — | — | — | — | — | — | — | — | — | — | 0.6 |
| antioxidant | | | | | | | | | | | |
| (parts by weight*) | | | | | | | | | | | |

*parts by weight: a unit based on 100 parts by weight of the base resin (A)

### EXPERIMENTAL EXAMPLES

The pellets according to Examples 1 to 4 and Comparative Examples 1 to 7 are dried at 100° C. for more than or equal to 3 hours and injected at a molding temperature ranging from 250 to 270° C. and a die temperature ranging from 60 to 80° C. using a 10 oz injection molding machine, to prepare specimens. The properties of the specimens are measured using the following methods. The results are provided in the following Table 2.

(1) Impact strength: Impact strength (¼″, 23° C.) is measured according to ASTM D256.

(2) Flexural modulus: measured according to ASTM D790 (2.8 mm/min).

(3) Heat resistance: measured according to ASTM D648 (18.5 kg).

(4) Thermal stability: a specimen is extruded by setting a barrel temperature of an injection molding machine at 280° C. and then maintaining it for 15 minutes in a 20 cm×6 cm×0.3 cm mold with a surface temperature of 80° C., and the amount of gas generated on the surface is then determined.

(5) Dimensional stability: a specimen is extruded by setting a barrel temperature of an injection molding machine at 260° C. and then cooling it down for 2 to 10 seconds in a 20 cm×6 cm×0.3 cm mold with a surface temperature of 60° C. and evaluating the warpage degree.

warpage degrees: O (no warpage)<Δ (a little warpage)<x (severe warpage)

TABLE 2

| | | Example | | | | Comparative Example | | | | | | |
|---|---|---|---|---|---|---|---|---|---|---|---|---|
| | | 1 | 2 | 3 | 4 | 1 | 2 | 3 | 4 | 5 | 6 | 7 |
| Impact strength | | 51 | 59 | 56 | 57 | 43 | 46 | 53 | 60 | 54 | 45 | 56 |
| (kgf · cm/cm) | | | | | | | | | | | | |
| Flexural | | 21,000 | 21,100 | 21,500 | 21,000 | 22,300 | 21,200 | 18,900 | 19,500 | 20,800 | 22,800 | 22,000 |
| modulus | | | | | | | | | | | | |
| (kgf/cm²) | | | | | | | | | | | | |
| Heat | | 122 | 127 | 128 | 125 | 118 | 127 | 120 | 110 | 125 | 113 | 126 |
| resistance | | | | | | | | | | | | |
| (° C.) | | | | | | | | | | | | |
| Thermal | | ∘ | ∘ | ∘ | ∘ | Δ | ∘ | ∘ | ∘ | x | ∘ | x |
| stability | | | | | | | | | | | | |
| Dimensional | 2 sec | ∘ | ∘ | ∘ | ∘ | x | x | ∘ | ∘ | ∘ | ∘ | ∘ |
| stability | 5 sec | ∘ | ∘ | ∘ | ∘ | Δ | x | ∘ | ∘ | ∘ | ∘ | ∘ |
| | 10 sec | ∘ | ∘ | ∘ | ∘ | ∘ | ∘ | ∘ | ∘ | ∘ | ∘ | ∘ |

Referring to Tables 1 and 2, the specimens including a polycarbonate resin, a polyester resin, a styrene-based polymer, an impact-reinforcing agent, and a phenol-based antioxidant according to Examples 1 to 4 have excellent mechanical properties such as impact resistance and strength and excellent heat resistance, thermal stability, and dimensional stability.

In contrast, the specimens according to Comparative Examples 1 to 7 have deteriorated mechanical properties, generated gas due to deteriorated thermal stability, or are transformed (changed) during a short extrusion cooling time due to deteriorated dimensional stability.

For example, Comparative Example 1 including polycarbonate resin and polyester resin in amounts outside of the ratio range of the present invention exhibited deteriorated impact resistance, and also deteriorated heat resistance, thermal stability, and dimensional stability. In addition, Comparative Example 2 including no styrene-based polymer exhibited deteriorated impact resistance and dimensional stability, while Comparative Examples 3 and 4 including a styrene-based polymer and an impact-reinforcing agent in amounts outside of the range of the present invention exhibited deteriorated mechanical strength or heat resistance. Furthermore, Comparative Example 5 including no phenol-based antioxidant and Comparative Example 6 including a phenol-based antioxidant in an amount outside of the range of the present invention exhibited either deteriorated heat resistance or thermal stability. In addition, Comparative Example 7 including no phenol-based antioxidant but with a non-phenol-based antioxidant hardly secured high thermal stability despite an increased amount of the non-phenol-based antioxidant.

Accordingly, a thermoplastic resin composition according to one embodiment can maintain good mechanical properties and excellent thermal stability but less post-transformation for a short cooling time and thus can provide improved appearance quality of an injection molded product and simultaneously improved productivity during the short extrusion cycle.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A thermoplastic resin composition, comprising:
(A) about 100 parts by weight of a base resin including (A-1) about 55 to about 80 wt % of a polycarbonate resin and (A-2) about 20 to about 45 wt % of a polyester resin;
(B) about 1 to about 10 parts by weight of a styrene-based polymer;
(C) about 1 to about 20 parts by weight of an impact-reinforcing agent; and
(D) about 0.01 to about 5 parts by weight of a phenol-based antioxidant, wherein the amount of (B), (C), and (D) are each based on about 100 parts by weight of the base resin.

2. The thermoplastic resin composition of claim 1, wherein the base resin (A) comprises about 60 to about 80 wt % of a polycarbonate resin (A-1) and about 20 to about 40 wt % of a polyester resin (A-2).

3. The thermoplastic resin composition of claim 1, wherein the polycarbonate resin (A-1) is prepared by reacting one or more diphenols with a compound comprising phosgene, a halogenic ester, a carbonate ester, or a combination thereof.

4. The thermoplastic resin composition of claim 1, wherein the polycarbonate resin (A-1) has a weight average molecular weight of about 10,000 to about 40,000 g/mol.

5. The thermoplastic resin composition of claim 1, wherein the polyester resin (A-2) is a polybutylene terephthalate resin or a polyethylene terephthalate resin.

6. The thermoplastic resin composition of claim 5, wherein the polybutylene terephthalate resin has an intrinsic viscosity [η] of about 0.35 to about 1.5 dl/g.

7. The thermoplastic resin composition of claim 5, wherein the polyethylene terephthalate resin has an intrinsic viscosity [η] of about 0.6 to about 1 dl/g.

8. The thermoplastic resin composition of claim 1, wherein the styrene-based polymer (B) is a polymerized polymer including about 60 to about 100 wt % of a styrene-based monomer and about 0 to about 40 wt % of a vinyl cyanide monomer.

9. The thermoplastic resin composition of claim 1, wherein the impact-reinforcing agent (C) is a core-shell structured copolymer prepared by grafting an unsaturated compound comprising an acrylic-based monomer, an aromatic vinyl monomer, an unsaturated nitrile monomer, or a combination thereof into a rubbery polymer prepared by polymerizing a diene-based monomer, an acrylic-based monomer, a silicon-based monomer, a styrene-based monomer, or a combination thereof.

10. The thermoplastic resin composition of claim 9, wherein the rubbery polymer comprises polybutadiene; a copolymer of butadiene and alkyl(meth)acrylate; a terpolymer of butadiene, alkyl(meth)acrylate and cyclosiloxane; or a combination thereof.

11. The thermoplastic resin composition of claim 1, wherein the phenol-based antioxidant (D) comprises octadecyl-3-(3,5-di-t-butyl-4-hydroxyphenyl)propionate, pentaerythritol-ester, bis(3,3-bis(4′-hydroxy-3′-t-butylphenyl)butanoic acid)glycol ester, or a combination thereof.

12. The thermoplastic resin composition of claim 1, wherein the phenol-based antioxidant (D) is mixed with a phosphite-based antioxidant.

13. The thermoplastic resin composition of claim 12, wherein the phenol-based antioxidant (D) and the phosphite-based antioxidant are mixed in a weight ratio of about 1:4 to about 4:1.

14. The thermoplastic resin composition of claim 12, wherein the phosphite-based antioxidant comprises tris(2,4-t-butyl phenyl)phosphite, tris(nonylphenyl)phosphite, bis(2,6-d-t-butyl-4-methylphenyl)pentaerytritol diphosphite, or a combination thereof.

15. The thermoplastic resin composition of claim 1, wherein the thermoplastic resin composition further comprises an additive comprising an antibacterial agent, a heat stabilizer, an antioxidant, a release agent, a light stabilizer, a compatibilizer, an inorganic material additive, a surfactant, a coupling agent, a plasticizer, an admixture, a colorant, a stabilizer, a lubricant, an antistatic agent, a coloring aid, a flameproofing agent, a weather-resistance agent, an ultraviolet (UV) absorber, an ultraviolet (UV) blocking agent, a filler, a nucleating agent, an adhesion aid, an adhesive, or a combination thereof.

16. A molded product manufactured using the thermoplastic resin composition of claim 1.
